(19) United States
(12) Patent Application Publication
(10) Pub. No.: US 2006/0283789 A1
(43) Pub. Date: Dec. 21, 2006

(54) Pool and spa dual body sanitization system

(75) Inventors: Leonard J. Kadlec, Woodbury, MN (US); Patrick H. Kilawee, Hugo, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Ecolab Inc., Mendota Heights, MN (US)

(21) Appl. No.: 11/157,041

(22) Filed: Jun. 20, 2005

(51) Int. Cl. B01D 25/32

(52) U.S. Cl. 210/225; 422/3; 210/110; 210/739; 210/96.1

(57) ABSTRACT

A sanitizer generation system provides sanitizer to a plurality of bodies of water. The system includes a sanitizer generator, a plurality of circulation systems, and a control system that selectively connects the circulation systems to the sanitizer generator as needed to sanitize the bodies of water.

### CROSS-REFERENCE TO RELATED APPLICATION(S)

The present application is related to the concurrently filed application Ser. No. ______, “Automated Electrolyte Addition for for Salt Water Pools, Spas, and Water Features” and Ser. No. ______, “Dual Generator Single Power Source for Tandem Pool and Spa.”

### BACKGROUND OF THE INVENTION

The present invention relates to systems and methods for sanitizing pools and spas. In particular, the present invention involves use of a single sanitizer generator for generating sanitizer for multiple bodies of water.

Pools, spas, and water features have a circulation system that continually pumps water from the pool or spa through a filter, heater, and sanitizer feed system before returning the water back to the pool, spa, or water feature. The circulation system is necessary to maintain the body of water at sanitary conditions. The water passes through the filter to reduce the accumulation of foreign material, such as hair, soil, or solids, in the pool or spa. Once the water has been filtered, the water passes through the heater, where the water is heated prior to returning to the pool, spa, or water feature.

In addition to filtering, water in pools, spas, and water features also require regular sanitization in order to maintain hygienic conditions. Allowing sanitation levels to either fall below or rise above required specifications results in decreased efficiency of the system. Low levels of chemical sanitizer in the pool, spa, or water feature can contribute to algae blooms, bacterial breakouts, cloudiness in the water, and chemical imbalances. One method for sanitizing pool or spa water is by adding sodium chloride (NaCl) to the pool, spa, or water feature and passing the sodium chloride containing water through a chlorine generator where electrolysis converts the sodium chloride and water to sodium hypochlorite (NaOCl), by the following reaction:
2NaCl(aq)+2H₂O Cl₂(g)+H₂(g)+2NaOH(aq)→NaOCl(aq)+H₂O+NaCl(aq)+H₂(g).

The chlorine generator is capable of being powered on and off depending on the concentration of chlorine in the water. When there is a sufficient level of chlorine in the pool or spa water, the chlorine generator is powered off and no reaction takes place. Thus, water circulating through the circulation system is filtered and heated, but the composition of the water is not altered. When the level of chlorine has fallen to a minimum level, the chlorine generator is powered on and the sodium chloride and water passing through the chlorine generator is converted to sodium hypochlorite. The chlorine generator remains powered on until the concentration of chlorine in the water has reached a desired steady state level.

Oftentimes, both a swimming pool and a spa are installed. Although the volume of the pool is on average ten to fifteen times larger than the volume of the spa, the cost of the equipment for treating the pool and spa are not significantly different. Additionally, a facility on occasion will include more than two pools or spas in tandem. In either of these situations, installing a chlorine generator for each of the pools and spas can result in high equipment costs. Depending on the volumes of the pools and spas, one sanitizer generator is typically capable of producing a sufficient amount of sanitizer (eg. chlorine) for multiple pools and spas.

### BRIEF SUMMARY OF THE INVENTION

A sanitizer generation system of the present invention provides sanitizer to multiple bodies of water using a single sanitizer generator. The system includes the sanitizer generator, a circulation system for each body of water, and a control system for selectively connecting the circulation systems to the sanitizer generator, based upon need for sanitizer in the respective bodies of water.

### BRIEF DESCRIPTION OF THE DRAWINGS

FIG. 1 is a schematic diagram of a sanitizer generation system in accordance with the present invention connected to two bodies of water.

FIG. 2 is a schematic diagram of the sanitizer generation system in accordance with the present invention connected to five bodies of water.

### DETAILED DESCRIPTION

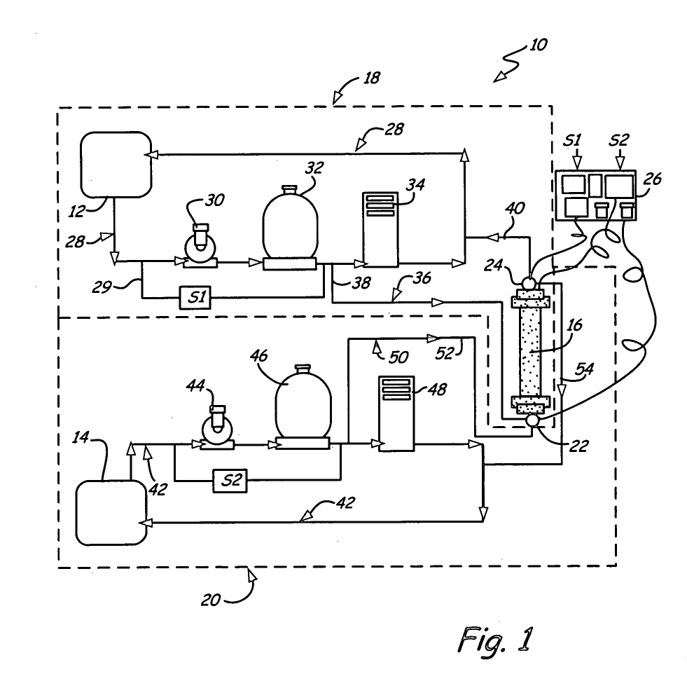

FIG. 1 is a schematic diagram of sanitizer generation system 10 in accordance with the present invention. System 10 is a single sanitizer generator, multiple pool sanitization system that maintains the sanitizer concentration in multiple bodies of water, such as pool 12 and spa 14, at a desired level by generating sanitizer with a single sanitizer generator 16. Pool 12 and spa 14 may be any combination of bodies of water to be treated. Using a single sanitizer generator to generate sanitizer for multiple bodies of water in close proximity to each other is beneficial for reducing the capital cost of such systems by as much as 50%.

Sanitizer generation system 10 is connected to pool 12 and spa 14 and generally includes pool and spa circulation systems 18 and 20, sanitizer generator 16, inlet valve 22, outlet valve 24, and controller 26. System 10 maintains the concentration of sanitizer in pool 12 and spa 14 at desired levels by controlling actuation of inlet and outlet valves 22 and 24. When there is a sufficient level of sanitizer in pool 12, system 10 is at steady state and sanitizer generator 16 is powered off. When the level of sanitizer concentration in pool 12 falls below a minimum level, controller 26 leaves the default operation of inlet valve 22 and outlet valve 24 so that inlet valve 22 allows water from pool 12 to enter sanitizer generator 16 and outlet valve 24 allows water leaving sanitizer generator 16 to return to pool 12. Pool circulation system 18 connects pool 12 to sanitizer generator 16 and transports water from pool 12 through sanitizer generator 16 and back to pool 12. When sanitizer is needed in spa 14, controller 26 activates inlet valve 22 and outlet valve 24 so that inlet valve 22 allows water from spa 14 to enter sanitizer generator 16 and outlet valve 24 allows water leaving sanitizer generator 16 to return to spa 14.

Pool circulation system 18 includes piping 28, circulation pump 30, filter 32, heater 34, sanitizer concentration sensor S1, side stream 36, and sanitizer generator 16. Circulation system 18 runs continuously and operates independently of sanitizer generator 16. Circulation pump 30 is typically positioned immediately downstream from pool 12 and pumps water from pool 12 through piping 28 and side stream 36.

Side stream 36 includes sanitization inlet line 38 and sanitization outlet line 40. Sanitization inlet line 38 is plumbed to circulation system 18 between filter 32 and heater 34 and connects pool 12 to sanitizer generator 16. When sanitization inlet line 38 branches from piping 28, some of the water flowing through piping 28 is diverted into sanitization inlet line 38 at a flow rate lower than the flow rate of the water flowing through piping 28. The water flowing through sanitization inlet line 38 passes inlet valve 22 and enters sanitizer generator 16. When there is a sufficient level of sanitizer in pool 12, sanitizer generator 16 is powered off and water passes through sanitizer generator 16 without being reacted. The water then passes through outlet valve 24 and leaves sanitizer generator 16 through sanitization outlet line 40, which connects to circulation system 18 at piping 28.

Because a pump is not plumbed to side stream 36, a pressure drop is required across pool circulation system 18 to maintain the flow of water in side stream 36 at a velocity sufficient to pass water through sanitizer generator 16 and back to pool 12. To create a pressure drop across circulation system 18, sanitization inlet line 38 is plumbed to circulation system 18 immediately after filter 32. Positioning sanitization inlet line 38 downstream from filter 32 and upstream from sanitizer generator 16 also ensures that only a minimal amount of foreign material present in the water enters sanitizer generator 16. The water from sanitization inlet line 38 leaves sanitizer generator 16 at sanitization outlet line 40, which connects to piping 28 downstream from heater 34 such that the water from sanitization outlet line 40 and the water from piping 28 combine prior to entering pool 12.

Spa circulation system 20 includes piping 42, circulation pump 44, filter 46, heater 48, sanitizer concentration sensor S2, side stream 50 including sanitization inlet line 52 and sanitization outlet line 54, and sanitizer generator 16 and functions in the same manner as pool circulation system 18.

Sanitizer generator 16 is an electrolytic cell that produces sanitizer from the water pumped through circulation systems 18 and 20 when sanitizer generator 16 is powered on. The water from pool 12 and spa 14 circulating through circulation systems 18 and 20 typically contains electrolyte that has been added to pool 12 and spa 14. When there is a sufficient level of sanitizer in pool 12 and spa 14, sanitizer generator 16 is powered off such that water passing through sanitizer generator 16 is not reacted. In one embodiment, sanitizer generator 16 is a watertight tube containing titanium plates coated with a precious metal. Although sanitizer generator 16 is shown in FIG. 1 as being plumbed in parallel with heaters 34 and 48, sanitizer generator 16 may also be plumbed in-line with heaters 34 and 48 without departing from the intended scope of the present invention.

Pool and spa sensors S1 and S2 are located in piping 28 and 42 of pool and spa circulation systems 18 and 20, respectively, and measure the sanitizer concentration of the water passing through circulation systems 18 and 20. Sanitizer generation system 10 is at steady state and sanitizer generator 16 is powered off when the sanitizer concentration of the water in circulation systems 18 and 20 are above a minimum level.

Controller 26 is in communication with sensors S1 and S2, inlet and outlet valves 22 and 24, and sanitizer generator 16 of sanitizer generation system 10. Sensors S1 and S2 have the ability to cause controller 26 to control the position of inlet and outlet valves 22 and 24 and power on sanitizer generator 16 to keep sanitizer levels in pool 12 and spa 14 within a specific range. In one embodiment, controller 26 is an Acu-Trol AK2100D controller with the capability to monitor sanitizer concentration.

Inlet and outlet valves 22 and 24 are each switchable between two positions. Inlet and outlet valves 22 and 24 are in a first position when power is being supplied to pool 12. The first position also serves as a default position when no power is being supplied to sanitizer generation system 10. Inlet and outlet valves 22 and 24 are in a second position when power is being supplied to spa 14. The first and second positions control whether water from pool 12 or water from spa 14 enters sanitizer generator 16. Inlet and outlet valves 22 and 24 are actuated simultaneously and are either both in the first position or the second position such that water from only one of pool 12 and spa 14 can enter sanitizer generator 16. When inlet and outlet valves 22 and 24 are in the first position, only water from pool 12 can flow through sanitizer generator 16 and return to pool 12. When inlet and outlet valves 22 and 24 are in the second position, only water from spa 14 can flow through sanitizer generator 16 and return to spa 14. In one embodiment, inlet and outlet valves 22 and 24 are three-way solenoid pilot valves.

When the sanitizer concentration of the water in pool 12 reaches a minimum level, controller 26 leaves valves 22 and 24 in the first position. In the first position, inlet valve 22 allows only water from pool 12 to pass through sanitization inlet line 38 into sanitizer generator 16 and outlet valve 24 allows water leaving sanitizer generator 16 to only pass through sanitization outlet line 40 to pool 12. Water from spa 14 cannot enter sanitizer generator 16 and water leaving sanitizer generator 16 cannot enter spa 14. Controller 26 also powers on sanitizer generator 16. Once sanitizer generator 16 is powered on, the water and electrolyte entering sanitizer generator 16 are reacted and converted to a sanitizer solution.

The sanitized water leaves sanitizer generator 16 through sanitization outlet line 40 and mixes with the water in piping 28 entering pool 12. Sensor S1 is located in side stream 29 of piping 28, bypassing pump 30 and filter 32 and using the resulting pressure drop for flow through side stream 29.

Sensor S1 continuously communicates the sanitizer concentration of the water in circulation system 18 to controller 26. As sanitizer is added to the water in circulation system 18, the sanitizer concentration of the water increases. Once the sanitizer concentration of the water reaches a desired steady state level, there is a sufficient amount of sanitizer in pool 12 and controller 26 powers off sanitizer generator 16. When sanitizer generator 16 is powered off, water from circulation system 18 continues to flow through sanitizer generator 16, but is no longer reacted.

Spa circulation system 20 and spa sensor S2 generally function and interact with inlet valve 22, outlet valve 24, sanitizer generator 16, and controller 26 in the same manner as pool circulation system 18 and pool sensor S1. When the sanitizer concentration of spa 14 falls below a minimum level, sensor S2 sends a signal to controller 26 to actuate inlet and outlet valves 22 and 24 to the second position and power on sanitizer generator 16. When inlet valve 22 is in the second position, only water from spa sanitization inlet line 52 can enter sanitizer generator 16. The water and electrolyte from spa 14 are then reacted in sanitizer generator 16. When outlet valve 24 is in the second position, the water leaving sanitizer generator 16 can only pass through spa sanitization outlet line 54 and return to spa 14. After the sanitizer concentration of the water in spa 14 has reached a desired steady state level, controller 26 powers off sanitizer generator 16 and valves 22 and 24. Valves 22 and 24 return to the first default position, allowing water from pool circulation system 18 to enter sanitizer generator 16.

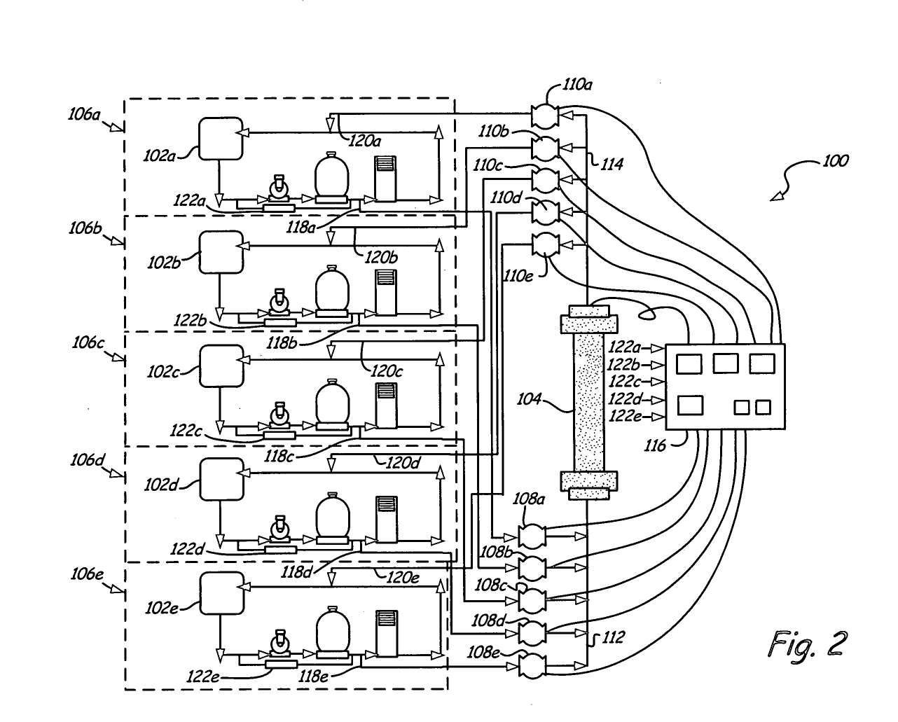

FIG. 2 is a schematic diagram of sanitizer generation system 100 connected to first pool 102a, second pool 102b, third pool 102c, fourth pool 102d, and fifth pool 102e. Sanitizer generation system 100 generally includes sanitizer generator 104; first circulation system 106a, second circulation system 106b, third circulation system 106c, fourth circulation system 106d, and fifth circulation system 106e; first inlet valve 108a, second inlet valves 108b, third inlet valves 108c, fourth inlet valves 108d, and fifth inlet valves 108e inlet valves; first outlet valve 110a, second outlet valve 110b, third outlet valve 110c, fourth outlet valve 110d, and fifth outlet valve 110e; inlet manifold 112; outlet manifold 114; and controller 116. Although system 100 is structurally different, it functions primarily in the same manner as system 10 of FIG. 1. The primary difference between sanitizer generation system 10 and sanitizer generation system 100 is that system 100 is capable of sanitizing multiple pools. Although FIG. 2 depicts system 100 connected to five pools, system 100 can be connected to any number of pools, spas, or other bodies of water as long as the sanitizer generator of the system is capable of producing enough sanitizer for all the bodies.

Each circulation system 106a-106e includes sanitization inlet line 118a-118e, sanitization outlet line 120a-120e, and sanitizer concentration sensors 122a-122e, respectively. Sanitization inlet lines 118a-118e connect circulation systems 106a-106e to sanitizer generator 104, respectively, through inlet manifold 112. Sanitization outlet lines 120a-120e connect sanitizer generator 104 to circulation systems 106a-106e, respectively, through outlet manifold 114.

Inlet and outlet valves 108a-108e and 110a-110e of each pool 102a-102e are actuated simultaneously and are either both open or both closed. Both inlet and outlet valves 108a-108e and 110a-110e of each pool 102a-102e must be actuated simultaneously in order to maintain the water level in each pool 102a-102e at a desired level and to minimize cross-contamination of water among pools 102a-102e. Controller 116 is in communication with sensors 122a-122e, inlet valves 108a-108e, outlet valves 110a-110e, and sanitizer generator 104. When sensor 122a communicates to controller 116 that sanitizer is needed in first pool 102a, controller 116 powers on sanitizer generator 104 and actuates first inlet and outlet valves 108a and 110a to an open position. All other inlet and outlet valves 108b-108e and 110b-110e remain in a closed position. When first inlet valve 108a is open, water is allowed to flow from first sanitization inlet line 118a through inlet manifold 112 and into sanitizer generator 104. After the water and electrolyte are reacted in sanitizer generator 104, the sanitizer leaves sanitizer generator 104 through outlet manifold 114. Because only first outlet valve 110a is open, the sanitizer can only flow through first sanitization outlet line 120a and back to first circulation system 106a.

The sanitizer generation system of the present invention provides sanitizer to a plurality of bodies of water using one sanitizer generator. Each body of water is connected to the sanitizer generator by a circulation system that circulates water from the body of water through the sanitizer generator. When a sensor in the circulation system of a first body of water communicates to a controller that the sanitizer concentration in the first body of water is at a minimum level, the controller powers on the sanitizer generator and simultaneously actuates an inlet valve and an outlet valve connected to the first body of water to an open position. When the inlet and outlet valves are in the first position, water from the first body of water is allowed to enter the sanitizer generator. As sanitizer is added to the circulation system, the sanitizer concentration of the water increases. Once the sanitizer concentration in the first body of water reaches a desired level, the controller actuates the inlet and outlet valves connected to the first body of water to a closed position and powers off the sanitizer generator.

Although the present invention has been described with reference to preferred embodiments, workers skilled in the art will recognize that changes may be made in form and detail without departing from the spirit and scope of the invention.

1. A sanitizer generation system for providing sanitizer to a first and a second body of water, the system comprising:
(a) a sanitizer generator;
(b) a first circulation system circulating water from the first body of water to the sanitizer generator;
(c) a second circulation system circulating water from the second body of water to the sanitizer generator; and
(d) a control system for selectively connecting the first and second circulation systems to the sanitizer generator.

2. The system of claim 2, and further comprising a first and a second sensor located in the first and second circulation systems, respectively, wherein the sensors sense a parameter of the water.

3. The system of claim 2, wherein the parameter sensed by the sensors is sanitizer concentration of the water.

4. The system of claim 2, wherein the control system selectively connects the first and second circulation systems to the sanitizer generator as a function of the parameter sensed by the first and second sensors.

5. The system of claim 4, wherein the control system includes a first inlet valve and a first outlet valve connected to the sanitizer generator, and a controller for controlling operation of the first inlet valve and the first outlet valve.

6. The system of claim 5, wherein the first inlet valve and the first outlet valve are each three-way valves.

7. The system of claim 6, wherein the first inlet valve allows water from the first circulation system to enter the sanitizer generator when the first inlet valve is in a first position, and wherein the first outlet valve allows water from the sanitizer generator to enter the first circulation system when the first outlet valve is in a first position.

8. The system of claim 7, wherein the first inlet valve allows water from the second circulation system to enter the sanitizer generator when the first inlet valve is in a second position, and wherein the first outlet valve allows water from the sanitizer generator to enter the second circulation system when the first outlet valve is in a second position.

9. The system of claim 4, wherein the control system further includes a second inlet valve and a second outlet valve connected to the sanitizer generator and controlled by the controller.

10. The system of claim 9, wherein the first inlet valve and the first outlet valve connect the first circulation system to the sanitizer generator, and wherein the second inlet valve and the second outlet valve connect the second circulation system to the sanitizer generator.

11. A sanitizer generation system for providing sanitizer to a plurality of bodies of water, the system comprising:
(a) a sanitizer generator;
(b) a plurality of circulation systems for circulating water from the plurality of bodies of water to the sanitizer generator; and
(c) a control system for selectively connecting the plurality of circulation systems to the sanitizer generator as needed to sanitize the bodies of water.

12. The system of claim 11, and further comprising a plurality of sensors located in the plurality of circulation systems, wherein the sensors sense a parameter of the water.

13. The system of claim 12, wherein the control system selectively connects the plurality of circulation systems to the sanitizer generator as a function of the parameter sensed.

14. The system of claim 13, wherein the control system includes a plurality of inlet valves and a plurality of outlet valves connected to the sanitizer generator, and a controller for controlling operation of the plurality of inlet valve and the plurality of outlet valves.

15. An automated method of sanitizing a first body of water and a second body of water with a single sanitizer generator, the method comprising:
(a) circulating water from the first and second bodies of water through a first circulation system and a second circulation system, respectively, the first and second circulation systems connected to the sanitizer generator;
(b) selectively enabling water from the first body of water to flow through the sanitizer generator while the sanitizer generator is operating; and
(c) selectively enabling water from the second body of water to flow through the sanitizer generator while the sanitizer generator is operating.

16. The method of claim 15, and further comprising:
(d) sensing a parameter of the water; and
(e) controlling production of sanitizer in the first and second bodies of water as a function of the parameter sensed.

17. The method of claim 16, wherein selectively enabling water from the first body of water to flow through the sanitizer generator and selectively enabling water from the second body of water to flow through the sanitizer generator occurs independently of each other.
